(19) United States
(12) Patent Application Publication
(10) Pub. No.: US 2014/0379818 A1
(43) Pub. Date: Dec. 25, 2014

(54) AGGREGATING MESSAGE RESPONSES INTO TOPIC-ORGANIZED CONTENT

(71) Applicant: International Business Machines Corporation, Armonk, NY (US)

(72) Inventors: Gary D. Cudak, Creedmoor, NC (US); Eric J. Kaiser, Raleigh, NC (US); Christopher J. Hardee, Raleigh, NC (US); Laura R. Kaiser, Raleigh, NC (US)

(73) Assignee: International Business Machines Corporation, Armonk, NY (US)

(21) Appl. No.: 13/963,170

(22) Filed: Aug. 9, 2013

Related U.S. Application Data
(63) Continuation of application No. 13/924,780, filed on Jun. 24, 2013.

(51) Int. Cl. H04L 12/58

(52) U.S. Cl. CPC H04L 51/16
USPC 709/206

(57) ABSTRACT

A computer processor receives a response to an electronic message, the response containing content elements. The computer processor determines one or more topics based on the content elements of the response to the electronic message. The computer processor reorganizes the response to the electronic message, such that the content elements are aligned with similar-topic content elements and associated with one of the one or more topics of the response to generate a topic organized aggregate message, and in response to receiving an additional response to the electronic message, the computer processor updates the topic organized aggregate message to include one or more additional content elements from the additional response, wherein the one or more additional content elements are aligned with the one or more topics of the topic organized aggregate message.

### CROSS REFERENCE TO RELATED APPLICATION

This application is a continuation of U.S. patent application Ser. No. 13/924,780 filed Jun. 24, 2013 the entire content and disclosure of which is incorporated herein by reference.

### BACKGROUND

The present invention relates generally to the field of electronic communications, and more particularly to aggregating the content of multiple electronic communication replies within a restructured electronic message that includes threads organized by similar topics.

Electronic messaging has become an integral part of daily communication activity. Electronic messaging, such as email, enhance personal lives by enabling friends and family to plan activities, keep informed, and share events and experiences, regardless of location or separation distance. Other forms of electronic messaging, such as internet forums and messaging boards enable intellectual, political, social and other areas of online interaction including discussion, exchange of ideas, sharing of information, stating and defending opinions, and providing sources of knowledge, among a multitude of users. Electronic messaging is similarly used in business environments to share information, develop and discuss ideas, identify and solve problems, collaborate, efficiently communicate, and keep employees at all levels of the business informed.

Users of current electronic messaging implementations may find difficulty in navigating through multiple responses to locate content that is similarly related to other content within a stream of responses. A user may also find it even more of a challenge to efficiently digest the related, but disparately presented content. Original entries by an author using one of the social media platforms are typically viewed by multiple recipients or viewers. Replies to the original entry, unless otherwise designated, are viewable by the same audience receiving or viewing the original entry. For email, this is equivalent to a list of recipients receiving an email and sending a response using the “reply to all” option. Entries for online forums and message boards, and possibly other social media platforms typically are not targeted to specific recipients, but are viewable by audiences that have permission to access, view and respond to the media entry.

As responses to an original entry are made, followed by responses to the responses, and so forth, a thread develops. A thread is a sequence of strands of topic-related content, typically text, in a continual and progressive stream of responses. The collection of the original message or entry and all the subsequent levels of responses comprise the stream.

A topic thread with a sequence of responses can diverge from the subject of the original message. A thread can develop at any level of the stream, and may result in a single lengthy sequence of similar topic response content, or branch in multiple directions and at multiple levels of the content stream. For example, an initial email to multiple recipients may produce a reply from each recipient to the originator and copying the other recipients. Each response is replied to and the content of each reply may include additional content related to topics diverging from the subject of the original email. Each email response that includes content with one or more additional topics, copied to the originator and other recipients, offers a thread for additional content in subsequent replies, however, the stream includes the collection of all levels of replies to the original email.

The responses in the above scenario from different recipients may include subsequent responses that take different directions and evolve to different topics or similar topics in different context. The email recipients and originator are challenged to effectively connect and digest the content in the context of related topics or to appropriately connect the various topics to the original subject.

### BRIEF SUMMARY

Embodiments of the present invention disclose a method, computer program product, and computer system for organizing responses to an electronic message. A computer processor receives a response to an electronic message, the response containing content elements. The computer processor determines one or more topics based on the content elements of the response to the electronic message. The computer processor reorganizes the response to the electronic message, such that the content elements are aligned with similar-topic content elements and associated with one of the one or more topics of the response to generate a topic organized aggregate message, and in response to receiving an additional response to the electronic message, the computer processor updates the topic organized aggregate message to include one or more additional content elements from the additional response, wherein the one or more additional content elements are aligned with the one or more topics of the topic organized aggregate message.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a block diagram illustrating various user interface attributes of a thread-organized aggregate message 1, in accordance with an embodiment of the present invention.

FIG. 3 is a flowchart depicting operational steps of a similar-topic organized, content aggregating program, on a computing device within the data processing environment of FIG. 1, in accordance with an embodiment of the present invention.

FIG. 4 is a flowchart depicting operational steps of a module of a similar-topic organized, content aggregating program, on a computing device within the data processing environment of FIG. 1, in accordance with an embodiment of the present invention.

FIG. 5 depicts a block diagram of components of a computing device executing the thread aggregating program, in accordance with an illustrative embodiment of the present invention.

### DETAILED DESCRIPTION

Embodiments of the present invention recognize that multiple iterations of responses to electronic messages, distributed to or available to multiple recipients, create a stream of content including additional topics evolving from the initial subject matter, and a complex set of interconnected threads of content. In environments that depend upon collaborative communications, resolving the progression of content can be a significant challenge. Valuable content may remain unnoticed or fail to be connected to other content, due to the complexity of the levels and branching of responses.

Embodiments of the present invention provide the ability to create a reorganized electronic message that determines content within responses associated with similar topics, responders and context. The similar topic content elements are presented in organized threads, associated with topics, having a logical sequence, differentiation of responders, and access to original responses.

Implementation of such embodiments may take a variety of forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

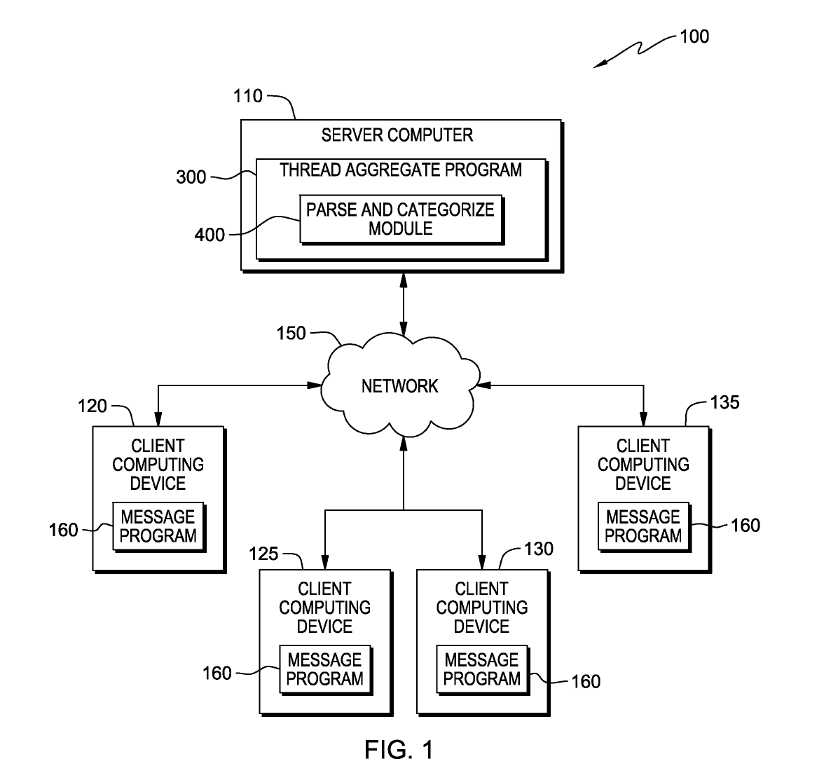

FIG. 1 is a functional block diagram illustrating a distributed data processing environment, referred to hereafter as distributed data processing environment 100, in accordance with an embodiment of the present invention. Distributed data processing environment 100 includes client devices 120, 125, 130, and 135, as well as server computer 110, all interconnected via network 150.

Network 150 can be, for example, a local area network (LAN), a wide area network (WAN) such as the Internet, or a combination of the two, and can include wireline or wireless connections. In general, network 150 can be any combination of connections and protocols that will support communications via various channels between server computer 110, client computing devices 120, 125, 130 and 135, in accordance with an embodiment of the invention.

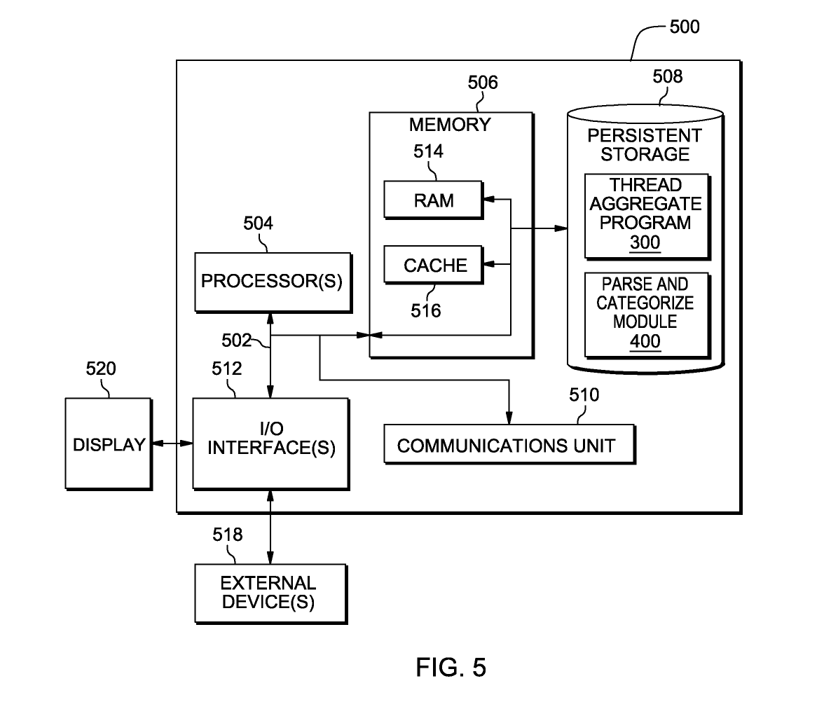

Client devices 120, 125, 130, and 135, may be a desktop computer, laptop computer, a specialized computer server, a client computer, tablet, or netbook personal computer (PC), a personal digital assistant (PDA), a smart phone, a mainframe computer, or a networked server computer. Further, client devices 120, 125, 130, and 135, can represent computing systems utilizing clustered computers and components to act as single pools of seamless resources when accessed through network 150, as is common in data centers and with cloud computing applications. In general, client devices 120, 125, 130, and 135, are representative of any programmable electronic device or combination of programmable electronic devices capable of executing machine-readable program instructions. Client devices 120, 125, 130, and 135, may include internal and external hardware components, as depicted and described in further detail with respect to FIG. 5.

Client devices 120, 125, 130, and 135, include respective copies of message program 160 which is a program that enables a user to participate in electronic message communications. In one embodiment of the present invention, message program 160 is an email program that sends and receives email messages by interaction with an email server, such as server computer 110, for example, via network 150. In another embodiment, message program 160 is a web browser that enables client computing devices 120, 125, 130, and 135, to connect to internet email services or alternatively access and participate in online forums or message boards.

An online forum, often referred to as a discussion forum or message board, is a type of electronic message communication in which users participate in online discussion in the form of posted messages and responses. Discussion forums have a hierarchical tree-like structure, typically pertaining to a defined subject area. A discussion forum begins with a message that is entered by a moderator of the forum or of the specific subject matter area of the forum, or other authorized user of the forum, and is displayed for view by participating users, to which responses can be added, referred to as “posts”. A stream of related topic posts is referred to as a “thread”, and a subject matter within an online forum may expand into multiple threads.

Server computer 110 may be a desktop computer, laptop computer, a specialized computer server, a client computer, tablet, or netbook personal computer (PC), a personal digital assistant (PDA), a smart phone, a mainframe computer, a web server computer, or a networked server computer. Further, server computer 110 can represent computing systems utilizing clustered computers and components to act as single pools of seamless resources when accessed through network 150, as is common in data centers and with cloud computing applications. In general, server computer 110 is representative of any programmable electronic device or combination of programmable electronic devices capable of executing machine-readable program instructions. Server computer 110 may include internal and external hardware components, as depicted and described in further detail with respect to FIG. 5.

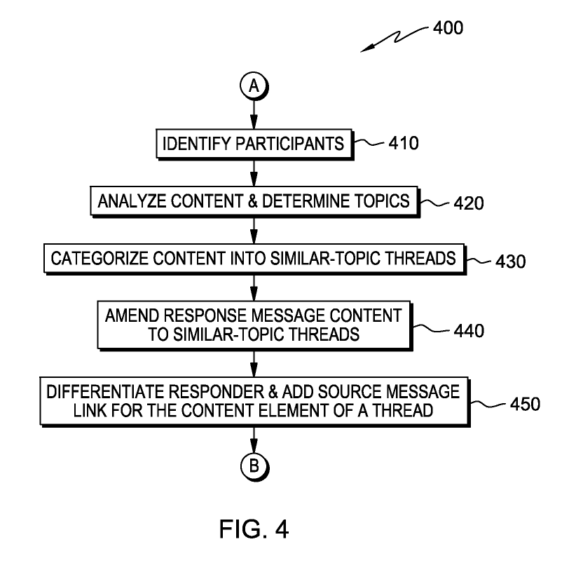

Server computer 110 includes thread aggregate program 300, which is a program that receives message responses to electronic communications messages, such as email or online forum postings, and reorganizes the content into a single, aggregate, easier-to-digest message. Thread aggregate program 300 uses the subject matter and topics of the subject matter determined from the content of the message by parse and categorize module 400. Parse and categorize module 400 is a module component of thread aggregate program 300 that segments the content of the stream of multiple electronic communication messages and determines content-topic relationships. Parse and categorize module 400 identifies participants of a message stream, analyzes the content to determine topics and relationship of content to the topics, and categorizes content to topics, enabling a reorganization of content from multiple messages to be included in an organized, aggregate, topic-based message. Parse and categorize module 400 will be discussed in more detail in regard to FIG. 4.

Thread aggregate program 300 reorganizes the parsed content elements and categorizes the content elements into similar topic threads and distributes the aggregate message to participants of the communication messages, providing a single aggregate, topic-organized message replacing the multiple postings or distribution of multiple responses and responses to multiple responses. The participants of communication messages include the message initiator, recipients, responders of the initial message, and responders of subsequent reply messages, including replies to replies.

For example, an initiator of an email message sends the email to a distribution list of recipients. The recipients may choose to respond to the original message and become responders, and the response they send includes a distribution list of the recipients. The progression of response and reply may continue until the discussion is complete, or interest has declined. The result may be a multitude of emails with a significant level of complexity to determine the relationship of a response to a previous email, and a subsequent response to a response. As the responses progress, the emails may include additional topics, and previous topics may evolve to different topics, making the relationship, flow and comprehension of the communications difficult at best, and impossible in some cases.

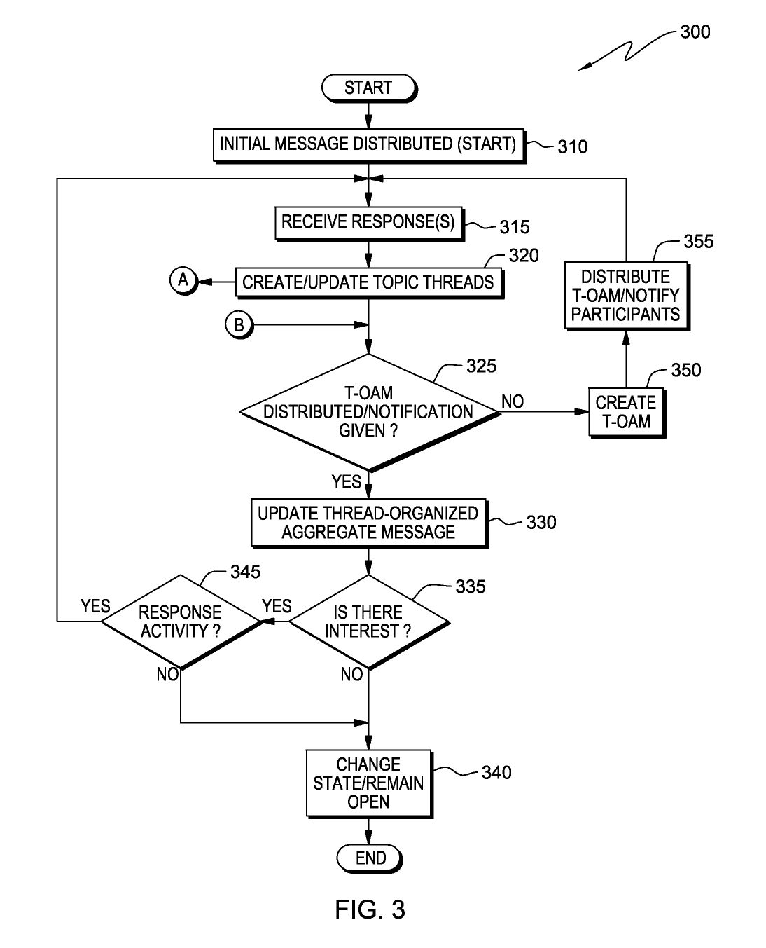

For the example case of an online forum, messages are presented in a sequential listing and a response to a post typically includes some or all of the content to which the response applies, however, after numerous responses from multiple participants, following the continuity of a topic thread may require constant searching up and down the listing of posts to locate a related message in an attempt to understand the flow of the topic discussion. Thread aggregate program 300 will be discussed in more detail in regard to FIG. 3.

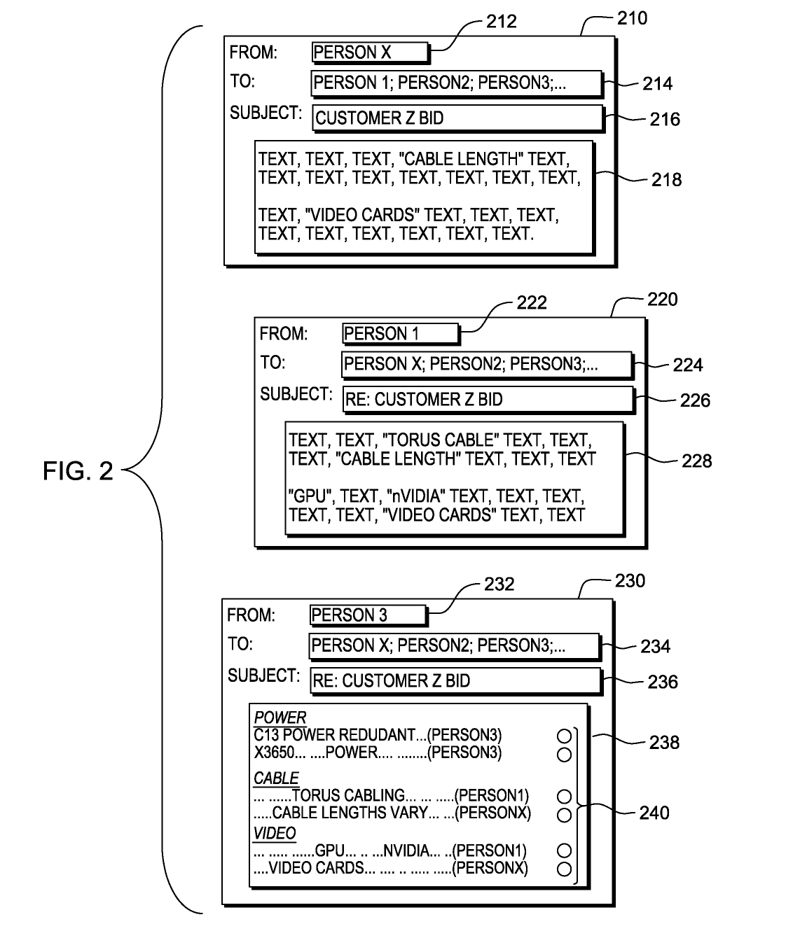

FIG. 2 is a block diagram illustrating user interface attributes of a thread-organized aggregate message, in accordance with an embodiment of the present invention. Although embodiments of the present invention may apply to different communication platforms, an email example is used for discussion purposes. Initial message 210 is a representation of a first communications message, response message 220 is a representation of a response message to initial message 210, and organized response 230 is representative of a response to response message 220, that has been reorganized into a thread organized aggregate message (TOAM), including topics and hyper-links to the source message of a corresponding content element.

Initial message 210 includes author field 212, recipient list 214, subject field 216 and content 218. Author field 212 contains identity information of the user authoring and sending the message. Recipient list 214 includes a listing of identity information of users for which the message is intended. Subject field 216 includes information regarding the overall subject matter of the message content, and content 218 contains the specific content of the message.

For example, “person x” is the identity information of initial message 210 that is intended for “person 1, person 2, person 3, . . . and possibly others, as indicated by recipient list 214. The subject of the message has to do with a bid from “customer z” as indicated in subject field 216. Content 218 illustrates the content of the message as including “cable length” and “video cards” as potential topics within the body of the content.

Similarly, response message 220 includes author field 222, recipient list 224, subject field 226 and content 228, however, response message 220 is authored by “person 1” who is a recipient of initial message 210, is directed to person x and other recipients of initial message 1, and content 228 differs from content 218 of initial message 210. For example, although subject field 226 refers to the same subject matter, it is noted that the “Re:” in the subject field indicates that the message is a reply to a previous message. The text content of the original and response messages can be analyzed and used to determine topics within the subject matter, “customer z bid”.

Content 228 is an example of content elements of response message 220 and includes and element referencing “torus cable”, and one referencing “nVIDIA” in addition to reiterating the references to “cable length” and “video cards” from content 218 of initial message 210. The reference to “torus cable” is aligned with the topic “cable length” from the initial message, indicating that the content of the response message is analyzed by parse and categorize module 400, introduced above, and “like-topic content” is associated and positioned in an organization that facilitates following a thread of like-topic content and discussion. Similarly, content 228 depicts “nVIDIA” as associated and organized with the “video cards” topic of the original message.

Organized response 230 includes content from a reply to response 220, and depicts additional structure and organization included in a thread organized aggregate message. Organized response 230 is authored by person 3 as indicated in author field 232 and person 3 may include responses in content 238 that are associated with the content of initial message 210 or response message 220. Recipient list 234 includes recipients and authors of initial message 210 and response 220 and in some embodiments of the present invention, additional recipients may be included. Subject field 236 indicates that the message is a response (reply, “Re:”), and includes the same subject matter as the original and response messages. Content 238 includes additional text from the author, person 3, and depicts that an additional topic, items related to the term “power”, has been identified in addition to previous topics of “cable” and “video”.

Organized response 230 also includes source message links 240, which are active hyper-links that when selected, access and display the original full-text message from which the associated topic content is sourced. Organized response 230 includes features of a thread organized aggregate message with the advantages of presenting content elements of multiple messages and responses in an aggregated organized format of topic threads. Source message links 240, included in organized response 230, aligns a link to the original source message with the extracted and re-organized topic content, enabling quick access when reference to the topic content source is required.

FIG. 3 is a flowchart depicting operational steps of a similar-topic organized, content aggregating program, on a computing device within the data processing environment of FIG. 1, in accordance with an embodiment of the present invention. In one embodiment of the present invention, thread aggregate program 300 resides on server computer 110, detecting and acting on messages posted to participants or distributed to recipients, and responses in reply from the participants or recipients. Thread aggregate program 300 identifies a message distributed to recipients (step 310), or in the case of a forum or message board, thread aggregate program 300 determines that a new (initial) message has been posted to the forum. The message is an initial message and includes a subject matter field, a content field or area, an author field and a recipient field, identifying participants of the message. The author and recipients of the initial message are each uniquely identified, for example, by an email address or a forum ID or handle. Thread aggregate program 300 associates the message, subject matter, author and recipients, and continues association to include subsequent responses by the recipients and author.

Recipients of the initial message may respond by sending a reply to the author and other recipients included in the initial message. Thread aggregate program 300 receives responses to the message (step 315), and in one embodiment, identifies a reply from an initial message or previous message by the message-ID header of the parent message, additionally, a response may include a reply designation, “Re:”, in the subject matter field of the response message indicating it is a reply, and may include part of or all of the previous message.

For example, person 1 sends a response to person “x”, who is the author of the previous message, and includes persons 2 and 3 as additional recipients because they were recipients of the previous message as well. Thread aggregate program 300 receives the response message and associates the response with the previous message and associates the recipients and author with the response. If person 1 had included an additional recipient, not included in the previous message, the additional recipient would be associated with person 1's response and subsequent response messages to person 1's response.

Having received a response, thread aggregate program 300 creates or updates topic threads (step 320). If the response received by thread aggregate program 300 is the first response message to an initial message, thread aggregate program 300 creates one or more topic threads associated with the initial message and response. If the response is subsequent to the first response of the initial message, thread aggregate program 300 updates previously created thread topics and adds additional thread topics as appropriate. The detail discussion of creating and/or updating topic threads continues to path “A”, depicted in FIG. 4.

FIG. 4 is a flowchart depicting operational steps of a program module of a content parsing and categorizing program, on a computing device within the data processing environment of FIG. 1, in accordance with an embodiment of the present invention. Thread aggregate program 300 includes parse and categorize module 400, which intervenes in the sending and receiving process of email, or the posting and displaying process of forums and message boards. After thread aggregate program 300 receives a response message, parse and categorize module 400 “intercepts” the message and identifies the participants associated with the response message (FIG. 4, step 410), and uses the identity of the participants to deliver or provide notification of a thread organized aggregate message (TOAM). A thread-organized aggregate message is a single updatable message that aggregates the content from multiple response messages and presents the content elements in a reorganized format in which similar-topic content elements are positioned together and aligned within a similar-topic thread. A TOAM is updated as additional responses are received and processed, as discussed below in further regard to FIG. 3.

For example, a response to the previous message authored by person “x”, and to recipients of the previous message, from person 1, is processed by parse and categorize module 400. The author and recipients are each determined by unique identification, for example, by an email address, a forum ID or a handle. Each identified participant is associated with the response and is included in delivery or notification of a resulting TOAM or update to an existing TOAM.

Parse and categorize module 400 analyzes the content and determines the topics of the response (step 420). The content of the response is analyzed to determine keyword and key-phrases in the context of the subject and content of the initial message, and using natural language processes (NLP), and other similar technologies, parse and categorize module 400 determines topics, subtopics and context of topics, that are included in the response message content and the associated initial message. NLP incorporates processing algorithms that provide certain rules and guidelines of speech and language in order for examination and analysis. At the syntactic level, algorithms may be developed to predict a part-of-speech for each word in the content of a message, as well as the various relationships between the words, such as subject, object, object-modifiers, and so on. The semantic component of NLP involves determining word combinations and relationships, such as noun-phrases from within free text, and labeling the noun-phrases as a person, organization, location or common noun. NLP algorithms consistently connect noun-phrase entities within and across response messages, and resolve the context and relationship of a noun-phrase within the other elements of the message content. The topics and related content are determined by statistical models using probabilities that attach weighted values to parsed elements and relationships of the content Likely association of the parsed content elements to topics is chosen by the highest probabilities determined.

Having determined topics within the response message, parse and categorize module 400 categorizes the content into similar-topic threads (step 430). Using NLP algorithms, parse and categorize module 400 connects subject and object components of content sentences and uses modifying phrases and words to establish relationship to similar-topic threads, and associates the content sentences and phrases to the categories of topic threads that have been determined. For example, a recipient of a message responds with message content that includes the noun-phrase “torus cable”, which parse and categorize module 400 associates with the topic thread “cables”, and categorizes the content that includes “torus cables” and additional content determined to qualify, modify or further describe or discuss “torus cables”, with the topic thread, “cables”.

Having categorized the response message content into similar topic threads, intercept program 400 amends the content to similar-topic threads (step 440). The response message content is categorized and aligned with a similar-topic thread with corresponding similar content. The amended content includes identification of the authoring participant and chronological information of the amended content. For example, as parse and categorize module 400 categorizes the content of response messages, such as the topic thread “video cards”, each similar-topic content element is categorized, for example “n-VIDIA”, which is a brand of video cards, is aligned with and amended to the similar-topic thread, “video cards”, and the “n-VIDA” content is distinguished as being authored by person 1.

Parse and categorize module 400 determines the source message that includes the response content elements that have been reorganized to align with similar-topic threads, and differentiates the author of the response message content and adds a source message link for the content element of the thread (step 450). For each response message received and processed by parse and categorize module 400, the content elements are differentiated to indicate the authoring responder. Differentiation can be achieved, but is not limited to the use of one or a combination of: text color that corresponds to a responder, differentiating font, different font size, levels of shading, highlighting, additional formatting such as underlining, enclosed in quotes, braces, brackets or parenthesis, and aligning an ID with a content element. Additionally, parse and categorize module 400 adds a source message link for each of the content elements aligned with the topic thread, which enables access to the original message from which content elements are sourced and rearranged to align with similar-topic threads.

Parse and categorize module 400 ends and returns control to thread aggregate program 300 (B, FIG. 3).

Returning to FIG. 3 (B), and having identified similar-topic threads and categorized content elements of response messages, thread aggregate program 300 determines if a T-OAM has been created for the current response message, and determining that a T-OAM has not been created (step 325, “No” branch), thread aggregate program 300 creates the T-OAM (step 350).

In one embodiment, the content elements are listed under a thread topic header and are presented in a chronologically related order. In other embodiments of the present invention, the content element responder differentiation is applied to each of the reorganized content elements and a source link is aligned adjacent to each content element.

Thread aggregate program 300 distributes the T-OAM or alternatively notifies participants of online forums and message boards (step 355). In one embodiment of the present invention, for email messages and responses, an updatable T-OAM is delivered to the identified participants of the initial and response messages. The T-OAM includes the content of the initial and response messages; however, the content elements are rearranged and organized in similar-topic threads, with content elements differentiated by responder and including a link to access the original message from which the content element is sourced. The T-OAM replaces the multitude of related email responses and responses to responses that can fill email in-boxes and significantly complicate a user's effort to comprehend and accurately connect the similar topic content within the multitude of responses.

In an alternative embodiment of the present invention, thread aggregate program 300 notifies participating users of a forum or message board that a T-OAM has been posted, which presents the content elements related to topics and subtopics in organized and sequential threads. After distributing T-OAMs or notifying participants that a T-OAM is posted, thread aggregate program 300 loops to step 315 and waits to receive additional responses, and proceeds as described above.

If thread aggregate program 300 determines that a T-OAM associated with the response has previously been distributed or notification given, (step 325, “Yes” branch), thread aggregate program 300 updates the existing T-OAM (step 330), by adding similar-topic content elements to corresponding topic threads, and adding new threads, if any, as well as including differentiation of the content element responder and links to access the response message source of the content elements of the threads.

For example, determining that a T-OAM has previously been created for an identified initial message and responses, thread aggregate program 300 performs analysis on subsequent responses, identifies existing and new topic threads, categorizes content elements of the response and aligns the content elements to amend to the existing topic threads or to align with new topic threads as appropriate. Thread aggregate program 300 updates the T-OAM to reflect the additional content. Updates can be made by use of web services, or other techniques, upon access of the T-OAM by a user, in which the T-OAM connects with thread aggregate program 300 on server 110, for example, and checks for updates. If updated content is available, thread aggregate program performs the update and the T-OAM reflects the most current content elements from responses received.

Thread aggregate program 300 determines if there is interest remaining in the T-OAM of a response chain of messages, by the level of response activity, and determining that there is still interest (step 335, “Yes” branch), thread aggregate program 300 determines if there has been response activity within a predetermined time period, and determining that there has been recent response activity (step 345, “Yes” branch), thread aggregate program 300 loops to step 315 to receive additional responses and proceeds as described above.

If thread aggregate program 300 determines that there has been no response activity (step 345, “No” branch), then thread aggregate program 300 changes the state of the T-OAM, however the T-OAM remains open (step 340). Thread aggregate program 300 changes the state to indicate that the chain of responses is inactive or complete for a message requesting a Y/N response. The T-OAM remains “open” to potentially receive additional responses, until such time that the T-OAM is deleted or archived. In one embodiment of the present invention, in a T-OAM that includes multiple topic threads, the state of a topic thread is set to “inactive”, or “complete”, or other term to indicate that the specific thread is unlikely to receive additional responses, as opposed to changing the state of the entire T-OAM.

Similarly, if thread aggregate program 300 determines that no interest remains by participants for the response message threads of the T-OAM (step 335, “No” branch), thread aggregate program 300 changes the state of the thread of the T-OAM, which remains open (step 340), or changes the state of the entire T-OAM if all topics indicate no further interest. The topic or T-OAM state is changed to inactive, complete or another term that indicates the thread or entire T-OAM is unlikely to receive additional responses. The T-OAM remains “open” to potentially receive responses until such time that the T-OAM is archived or deleted. Upon archiving or deleting the T-OAM, thread aggregate program 300 ends.

In an embodiment of the present invention, thread aggregate program 300 includes preference settings that a participant may select, enter, or change. Thread aggregate program 300 enables the identification of an “expert” responder, whose response is highly valued and after whose response is received, may result in lower or no further interest for the topic thread. In one such embodiment of the present invention, thread aggregate program 300 sets, or offers an option to set the state of the topic thread to low interest, following a response from an expert for the topic.

An expert responder may be identified by Thread aggregate program 300 accessing a directory-type database that identifies people that may be participants or recipients of messages, and which includes indication of one or more subjects on which the identified person is considered an expert. Expert consideration may be obtained, for example, by input from other people recognizing a level of expertise, by attaining a certification, or by a keyword search of a resume or work history document included in the database. In another embodiment, thread aggregate program 300 includes a participant profile that a participant can indicate topics or areas of expertise. In yet another embodiment, thread aggregate program 300 receives feedback of content elements of a message that participants rate, and the ratings can be used to identify experts on a topic.

Expert responders receive additional differentiation for quick recognition when responses are presented in a T-OAM. Similarly, thread aggregate program 300 enables the identification or selection of “responders-that-matter” that offers additional efficiency in reviewing topic thread content. “Responders-that-matter” may be team members, customers, direct reports, or individuals with specific topic-related responsibilities that have a level of significance to a message participant. In one embodiment, responders-that-matter can be identified by thread aggregate program 300 by including the identity or ID code, of the responder(s) in a profile preference file. In other embodiments, responders-that-matter may be identified by thread aggregate program 300 accessing data that includes a responder's position, rank, level of authority, or role within an organization.

In other embodiments, thread aggregate program 300 enables a participant of a T-OAM to indicate an interest level for a topic thread. In one embodiment, participants may indicate “high interest” for a topic thread, and the corresponding topic thread may be highlighted, re-positioned in a more prominent location within the T-OAM, or differentiated in some manner for easy and prominent recognition. Alternatively a participant may indicate “no further interest” for an unimportant topic, in which case the topic thread may be labeled indicating no further interest and/or may be hidden from general view, or may be moved to an appropriately labeled folder or section.

The above discussions have implied that thread aggregate program 300 and parse and categorize module 400 reside on a server computer, such as server computer 110, however, in other embodiments, client computers may host thread aggregate program 300 and parse and categorize module 400. The client computers, operating thread aggregate program 300 and parse and categorize module 400, may receive, store and reorganize the content of received messages into a T-OAM, or extract content from forums or message boards then analyze and reorganize the content to form or update a T-OAM. Additionally, although email, forums and message boards are referenced in the above discussion, embodiments of the present invention are not limited to these forms of social media messages, and may be applied to other sources and instances of social media, given the appropriate access and permissions.

FIG. 5 depicts a block diagram of components of a computing device executing the thread aggregating program, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computer 110, and client computing devices 120, 125, 130, and 135, include communications fabric 502, which provides communications between computer processor(s) 504, memory 506, persistent storage device(s) 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage device(s) 508 are computer-readable storage media. In this embodiment, memory 506 includes random access memory (RAM) 514 and cache memory 516. In general, memory 506 can include any suitable volatile or non-volatile computer-readable storage media.

Thread aggregating program 300, parse and categorize module 400, and message program 160, are stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of server computer 110 and client devices 120, 125, 130, and 135. In these examples, communications unit 510 includes one or more network interface cards. Communications unit 510 may provide communications through the use of either or both physical and wireless communications links. Thread aggregate program 300, intercept module program 400, and message program 160, may be downloaded to persistent storage 508 through communications unit 510.

I/O interface(s) 512 allows for input and output of data with other devices that may be connected to server computer 110. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., thread aggregate program 300, parse and categorize module 400, and message program 160, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for organizing responses to an electronic message, the method comprising:
receiving a response to an electronic message, the response containing content elements;
determining, by a computer processor, one or more topics based on the content elements of the response to the electronic message;
reorganizing the response to the electronic message, such that the content elements are aligned with similar-topic content elements and associated with one of the one or more topics of the response to generate a topic organized aggregate message; and
in response to receiving an additional response to the electronic message, updating the topic organized aggregate message to include one or more additional content elements from the additional response, wherein the one or more additional content elements are aligned with the one or more topics of the topic organized aggregate message.

2. The method of claim 1, further comprising:
identifying participants of the electronic message and participants of the response to the electronic message; and
delivering the topic organized aggregate message to the participants of the electronic message and the participants of the response to the electronic message.

3. The method of claim 2, further comprising:
determining, by at least one computer processor, one of the participants to be a responder-that-matters, wherein the content elements from the responder-that-matters, aligned to a topic included within a topic organized aggregate message, are differentiated to be more recognizable than the content elements from another participant.

4. The method of claim 1, wherein the step of reorganizing the response to the electronic message, such that the content elements are aligned with similar-topic content elements and associated with one of the one or more topics of the response to generate a topic organized aggregate message, further comprises:
identifying, by one or more processors, each author for the content elements within the topic organized aggregate message; and
displaying an indicator of identity for each author of the content elements within the topic organized aggregate message.

5. The method of claim 1, further comprising:
receiving a selection of a link associated with one of the one or more content elements within the topic organized aggregate message, wherein the link accesses a source message that includes the content element; and
in response to receiving the selection of the link, displaying the source message that includes the content element.

6. The method of claim 1, further comprising:
determining, by a computer processor, an interest level for a first topic, by a participant;
in response to determining an interest level for the first topic by the participant, positioning, based on the interest level, the first topic and content elements associated with the first topic, within the topic organized aggregate message; and
displaying an indicator of the interest level aligned with the first topic.

7. The method of claim 1, further comprising:
receiving a response from a message responder of an electronic message that includes a first topic;
determining if the message responder is an expert of the first topic; and
in response to determining the message responder is an expert of the first topic, differentiating, by a computer processor, the response from the expert of the first topic as an expert response.

8. The method of claim 7, wherein differentiating, by a computer processor, the response from the expert of the first topic as the expert response, includes indicating within the topic organized aggregate message, low interest for additional responses to the first topic.

9. The method of claim 1, wherein in response to receiving the additional response to the electronic message, updating the topic organized aggregate message to include one or more additional topics each including one or more content elements associated with the one or more additional topics respectively, wherein the one or more additional topics each respectively including the one or more content elements, are added to the topic organized aggregate message.
